(19) United States
(12) Patent Application Publication
(10) Pub. No.: US 2024/0294255 A1
(43) Pub. Date: Sep. 5, 2024

(54) Wearable Propulsion Flight Systems Suited To The User Body

(71) Applicants: Jamel Williams, Alpharetta, GA (US); Jayden Williams, Alpharetta, GA (US); Aaliyah Burton, Alpharetta, GA (US)

(72) Inventors: Jamel Williams, Alpharetta, GA (US); Jayden Williams, Alpharetta, GA (US); Aaliyah Burton, Alpharetta, GA (US)

(21) Appl. No.: 18/661,359

(22) Filed: May 10, 2024

(51) Int. Cl. B64C 39/02; B64D 17/80

(52) U.S. Cl. CPC B64C 39/026; B64D 17/80

(57) ABSTRACT

The Invention corresponds to a technical equipment used to make an individual fly. For instance, the Invention relates to the gatherings of the propulsion units, that are worn near the user scapulas, to provide thrust that pushes the user forward, while the parachute carry the user off the ground creating an ultralight aircraft, the Inventors have realized that it is possible to design a wearable aircraft that uses propulsion units, suited to the human body, to push the user's body forward, while using a parachute and the user's strength for stable flight.

### BACKGROUND

This disclosure relates to an apparatus that allows an individual to fly. For example, the disclosure relates to the provision of propulsion assembly that can be worn near the user scapulas, to provide thrust that pushes the user forward, while the parachute carry the user off the ground.

There have been many attempts in the past to allow flight with only minimal equipment. Typically, such systems are formed of a wing framework.

### BRIEF SUMMARY OF THE DISCLOSURE

The Invention corresponds to a technical equipment used to make an individual fly. For instance, the Invention relates to the gatherings of the propulsion units, that are worn near the user scapulas, to provide thrust that pushes the user forward, while the parachute carry the user off the ground creating an ultralight aircraft.

It's been many trials and errors in history, to invent a superhero flying suit, which enables an individual to fly. Typically these kinds of aircraft are only in comic books. Most aircraft today are typically winged vehicle style frameworks that's connected to propulsion units.

The Inventors have realized that it is possible to design a wearable aircraft that uses propulsion units, suited to the human body, to push the user's body forward, while using a parachute and the user's strength for stable flight.

instead of using the winged vehicle style framework, the Invention will be used as a wearable aircraft using a parachute, and a propulsion system, as defined by the claims

A “Body Holdster” is meant to be a device that holds that produce thrust while holding the users body. A Body Holdster may contain one or more propulsion units, in which each will provide its own thrust or collectively. An example of this will be a wearable Propulsion unit that provides thrust in a targeted direction. The Propulsion unit provide thrust at a low force to the user weight. Each propulsion unit is able to provide maximum thrust to at least 40 pounds, but preferably to a maximum of 20 pounds, but Each Propulsion unit may control the production of lower or higher thrust using control signals.

What it means by being wearable is that the user wearing the “Propulsion units” are mounted to the users upper body, in a way that the “wearer” can use it in motion, as such, that it may not disrupt, the wearer natural sense of balance, movement of body, and use of arms and leg motion. The wearer contributes little to the motion of the propulsion holders and recognizes the difficulty to control the variety of thrust pressures, from the singularity of the propulsion units or the “units” working collectively.

The visible form of the Invention includes two Propulsion Units on a “Propulsion Holder”, connected to the flight systems, that control the propulsion unit, which are worn on the users upper body, while the user simultaneously controls the Parachute, in addition the user will be attached to a harness that's connected to the parachutes, which is worn by the wearer, with protective gear assembled on the wearer.

The Propulsion units will be signally mounted on the Body Holdster near the wearer scapulas, but in a slanted direction to the users scapulas, with its net thrust. space will be between the Propulsion unit and the body, near the user shoulders to scapula region, in which may further extend away from the user to a horizontal position.

It is referred to as net thrust instead of all thrust because even though there may be multiple Propulsion units that individually produce thrust, it may not be stabilizing in flight because of the differences in thrust pressures, but collectively, each Propulsion unit can generate force.

The physical condition for the wearer is that he or she is able to support his or her own weight using just their arms, and also be able to support their own weight on each foot, and able to twist their body with their own weight, and Also trainings on how to fly with a parachute. Additionally there may be a set of training exercises that test each Propulsion unit with the user body. In addition, the Holdster may provide differences in sizes for Propulsion units for the user body. The difference in sizes may be arranged for the “Holdster” to be suited to the individual upper body, To better the performance of the entire “Aircraft”. The Body Holdster may be designed to find the most fitting measurement to the user's human body to make the “Aircraft” more “Suited” to the user.

For the most part the load from the aircraft is half or majority carried by the Parachute but the propulsion units, near the scapulas, collectively will provide thrust. In another way of saying this, is that the thrust of the propulsion units near the user scapulas, provides a thrust, pushing the user forward, while the parachute creates lift by carrying the user, while the propulsion units will only push the user forward.

It has been found that providing thrust roughly equally between, the left scapula propulsion unit, and the right scapula propulsion unit collectively, in a counter-rotating fashion, preferably, provides a more stabilizing Propulsion System for the Aircraft.

The lift is produced by the parachute carrying the user off the ground, which is produced by laying the parachute on the ground in a spread out fashion, then the user run to lift the parachute off the ground, while the parachute is held in the air, it carries the user off the downhill ground, while the thrust push the user forward, While it's not detrimental for the propulsion units to push the user forward with its thrust, it is preferred. The Propulsion units produce thrust equally for better controls and stability. For the control of horizontal thrust and motion, the propulsion systems, moves the propulsion holder near the user shoulders, for horizontal thrust.

It is arranged in a way to support the net thrust of the Propulsion unit, to provide a net force forward, for that forward pressure may be enhanced by the wearer, by providing thrust in a forward direction, or in a downward direction to move forward or soften the landing. Thus making all of the Propulsion “Units” collectively provided an equilibrium (a way of equalizing the balance) vertically, and horizontally. An advantage of the Propulsion holders mounted on the scapulas, is that the air intake and exhaust from the Propulsion units is away from the user body and able to lift and soften the landing of the user, and in a way still allows air intake from the air flow.

The visible form of the “Holdster” mounted on the user body may comprise at least two propulsion units, in a spread out arrangement that produces thrust, and in that net thrust, they meet at a point but aligned in parallel. It's designed In a way to not point to the wearer body with its net thrust, for it's been added for the stability and the thrust of the overall system. The overall wearable aircraft invention may come with protective gear, but it has been found that is unnecessary, however it can be applied.

### BRIEF DESCRIPTION OF THE SEVERAL VIEWS OF THE DRAWINGS

To better understand the invention and how it may be put into effect, by the way of example only;
these references in drawing are shown:

FIG. 1 is the first visible form of the Invention Body Holdster worn near the scapula region of the user.

FIG. 2 is the side view visible form of the invention Body Holdster worn near the scapula region of the user.

FIG. 3 is the Backside visible form of the invention Body Holdster worn near the scapula region of the user.

FIG. 4 is the second visible form of the Invention Body Holdster with propulsion units in accordance with the motion of thrust worn near the scapula region of the user.

FIG. 5 is the first visible form of the aircraft with holding storage systems, including the showings of the protective gear, and the form of the aircraft, in accordance with the Invention.

FIG. 6 is the side view visible form of the aircraft with flight systems including the showings of the protective gear, and of the aircraft in accordance with the Invention.

FIG. 7 is the back side view visible form of the aircraft with flight systems, including the showings of the protective gear, and of the aircraft in accordance with the invention.

FIG. 8 is the second visible form in totality of the aircraft with devices that are included in the showing of the invention, with the form of the aircraft remote controllers.

### DETAILED DESCRIPTION OF THE DISCLOSURE

The Body Holdster mounted for the user's upper body is shown in:

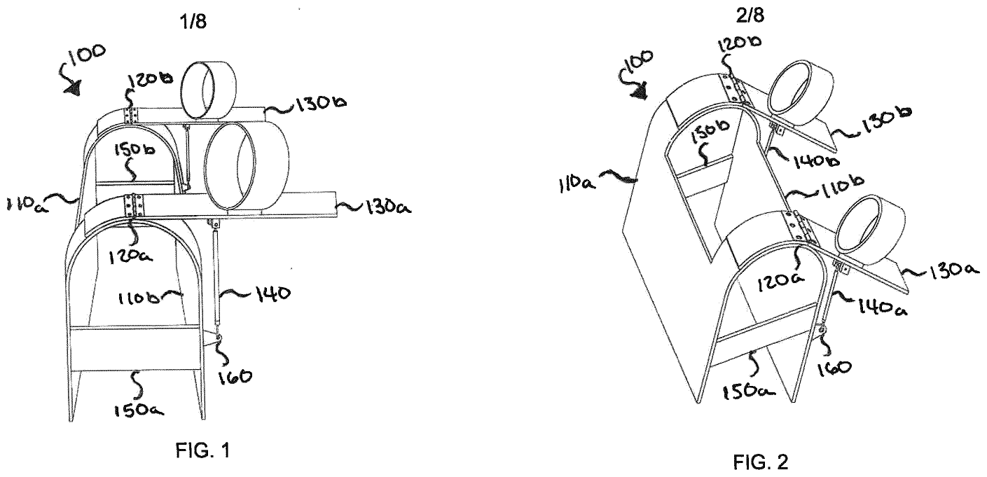

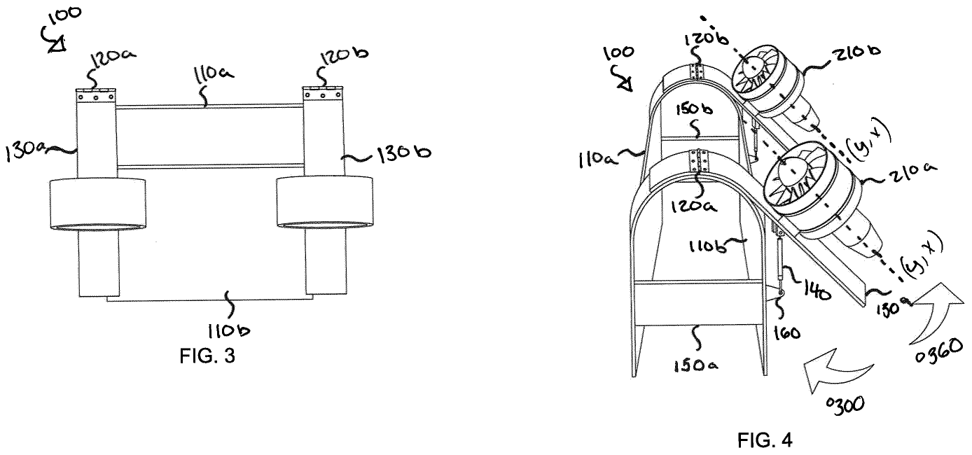

FIG. 1 to FIG. 4: which Is a wearable aircraft in accordance with the Invention, for it will have a “Body Holdster” 100.

The Body Holdster 100 is configured to apply thrust directly downward or applied thrust horizontally, to push the user forward, around the user's scapulas. The Body Holdster 100 consists of a chest plate 110 a and a back plate 110 b which is connected at the shoulders to make one Body Holdster assembly 100. It would compose of composite materials like aluminum or titanium, carbon fiber, wood or even strong clothing materials, but aluminum or a metal structure is mostly preferred.

The Body Holdster 100, comes with two propulsion holders 130 a and 130 b, and the hinges 120 a and 120 b, and a support 140a and 140b, and a side connector assembly 150a and 150b and a micro motor 160a and 160b. The Body Holdster 100 is suited around the body like a vest or body armor around the user body. It's preferable to come to lengths between 12 to 24 inches, but may come to a maximum of 36 inches, a height between 5 to 36 inches, and a weight between 1 to 30 pounds. Also, the width and height for the side connector assembly 150 is between 4 to 15 inches.

The hinges 120 is arranged to support the user's propulsion holders 130. For example, it may come with gears that moves the propulsion holders 130, downward or in a horizontal position, securing the user with at least one body propulsion holder 130a or another one 130b. Preferably, the user wears at least two propulsion holders 130 a and 130b, supported by the two support 140a and 140b, on the dorsal side of the user's body.

The hinges 120 may be configure to attached to a user's Body Holdster 100, located near the wearers shoulder region, preferably the hinges 120 is sized and shaped in such that the directions of the propulsion holders 130, with its thrust, can be applied downward or horizontal, to help the user body to be properly secure in a downward or horizontal force. The propulsion holder 130 however, is located between the user neck or the bottom of the user rib cage. But most preferably in level with the user scapula region.

The propulsion holder 130 is arranged to support at least one propulsion unit 210, at a fixed angle relative to the user's scapulas, while the whole body assembly 100 is worn and engaged with the user. The propulsion holder 130a is designed relative to the axis y, which is parallel in lining to its second propulsion holder 130b, usually located near the users scapulas on the dorsal side of the body. which can be found between the user neck and the bottom of the user rib cage, when the propulsion holder 130 is worn.

It is also beneficial to minimize interruptions in the thrust by providing a guard at the intake, for the intake is the source of interruptions, in the case, in which the propulsion holder 130 comprises the strings of the parachute 180, for it has the possibility To cause a momentary loss of thrust, and even shut down the engine.

The propulsion holders 130, propulsion units 210, elevation angle is considered to be at zero or negative than zero, in the dorsal side of the body holdster 100, for it is at least 300°, preferably no more than 360°,

This choice of elevation angle has been found to enhance the overall elevation and stability of the aircraft, in which protects the user's body from the intake and outtake of that produce thrust, and creates an relative elevation angle between the south axis y and the east axis x.

The support 140 holds at least one body Propulsion holder 130 at angle relative to the axis y, That angle has a elevation component, which the Propulsion units 210, net thrust elevation in the sagittal plane (the planes that divides the users the left side from the right side) can move horizontally or diagonally between the south axis y and the east axis x.

The Support 140 is comprised with a least two lifters, usually attached to the user back, like straps on a backpack, it's usually arranged to fit inside or outside of the Body Holdster 100, but preferably it's outside of the Body Holdster 100, but under the two propulsion holders 130a and 130b, as a lifter to the propulsion holders 130. It may be lowered, to lower the propulsion holders 130a and 130b. It may also be arranged to be attached to the user chest plate 110a as an inner or outer garment to the Body Holdster 100, usually for a specialized operation of the aircraft, but this set up usually requires a specialized training. The overall changes are usually based on the user body type and operation, but usually it's the comfortability of the overall suit.

Also in addition there is an option for maintaining the body Propulsion elevation, by providing a relative control with the micro motor 160, for controlling the elevation of the support 140.

The side connector assembly 150 comes with at least two plates or two straps that connect the chest plate, 110a with the back plate 110 b on the left and right side of the Body Holdster 100, in a way to have a firm foundation.

The harness 170, carries the user with a strap, or strong clothing material, that wraps around the users body, from thigh, to chest to shoulder region, which are attached to the parachute 180, while the parachute 180, keeps the user in the air or from falling.

Instead of engaging with the user's propulsion units 210 near the scapulas region (the upper back of the body). Preferably, the parachute 180, and its strings, can provide a relative control with its handles 190 a and 190 b. Which may come attached with or without the remote control 200a and 200b. to steer the parachute 180, in the left direction, or in a right direction using the handles 190.

The strings holding the parachute 180, may be arranged inside or outside the Body Holdster 100.

With its strings worn inside or outside of the Body Holdster 100, as an inner or outer assembly, so that the user can be carried, but it is preferred as an outer assembly, outside of the Holdster 100.

The parachute 180 sizes can range from 200 to 400 square feet, and can weigh roughly between 10 pounds to 30 pounds depending upon the preference of the user, for it may be as high as 50 pounds.

The size and the weight of harness 170, can vary, but a typical harness might weigh around 5-7 pounds, but a Harness length can be adjustable based on the user's body size, but can roughly be adjusted between 30 inch to 60 inches in length.

The overall body Holdster 100 preferably, includes at least the first propulsion holder 130a, a second propulsion holder 130b, The first Propulsion unit 210 a, and a second propulsion unit 210b, its arranged to provide a net force along the south axis y to the east axis x, described as the first Propulsion vector. The second propulsion vector provides counter rotating net force along the south axis y to the east axis x, described as the second Propulsion vector. The first and second Propulsion units located near the user's scapulas, on the dorsal side of the body, are not closely side by side, even though they are in parallel, they are directed apart to about 5 to 24 inches. The support 140 holds propulsion units 210 between the length of 5 to 24 inches, and width between 3 to 24 inches, and can hold a minimum thrust pressure of 1 pound to a max pressure of 60 pounds, but preferably at least 20 pounds but no more than 40 pounds. The best showing of this is in FIG. 4.

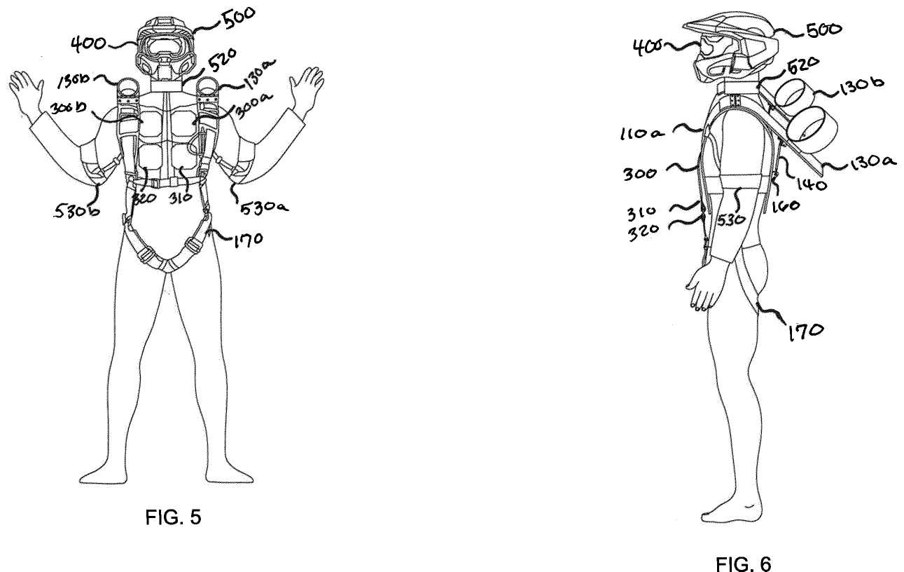

FIG. 5 is the visible form of the aircraft with holding storage systems in accordance with the Invention.

In FIG. 5 it shows The holding system in which the singular energy storage 300a and 300b are providing energy to the left-and right-propulsion units 210, which the energy storage 300a delivers energy to the propulsion units 210a, and the energy storage 300b delivers energy to the propulsion units 210b.

The Holding systems 300 also comprises an energy storage device 310 for providing power to the propulsion holders. This may also be a fuel storage vessel for supplying fuel to turbines and/or batteries for powering fans and/or control circuitry. The energy storage device 320 is preferably provided in the form of a bladder for fuel or in a pack to be worn on the user's lower back or be stomach-mounted for circuitry, and/or on the upper chest or upper dorsal side of the back. But the energy storage device 310 is mounted near the stomach, for energy storage purposes.

Since the holding systems 300 is preferably provided on the flight suit (i.e. onboard on the aircraft), it is preferable that when the energy storage device 300a and 300b, is compromise or the fuel storage vessel is low, it's best to keep an extra backup battery 310 or fuel storage 320, the backup is provided as a variable volume of storage, in this way it prevents risks when there have been issues with the engines.

For fuel propulsion units 210, it's The Preferable to use a bubble sensor, for sensing the presence of bubbles in fuel supply lines for supplying fuel to turbines. The bubble sensor is for alerting the user to the presence of bubbles. When the bubble signal exceeds a threshold, the user is alerted and may land, before the turbines fail. The alert may be audible or visual for example using the head-up display 400 described below.

FIGS. 5 to 7, is the showings of the protective gear additions that may fall into the scope of the claims.

The heads up display 400, may be embodied into a single device to be worn on the user's eyes or may be formed separately without its distributed devices. The flight control system 400 is arranged to provide a view of signals to the user from the experience of the propulsion units 210. The flight control system 400 may also be arranged to receive control signals from each propulsion unit 210. and/or from the energy storage device 300.

The protective gear, additions, preferably includes a helmet 500, which comprises a head-up display 400, which may be equipped with the camera on the back of the helmet 510, with a protective gear for the neck 520, and a armpit band 530a and 530b, that represents the lifting of the upper arms, to protect the arms from fatigue, when holding the parachute handles 190. While the head-up display 400 represents or communicates the health of the user body, and/or the speed of travel with the propulsion units 210.

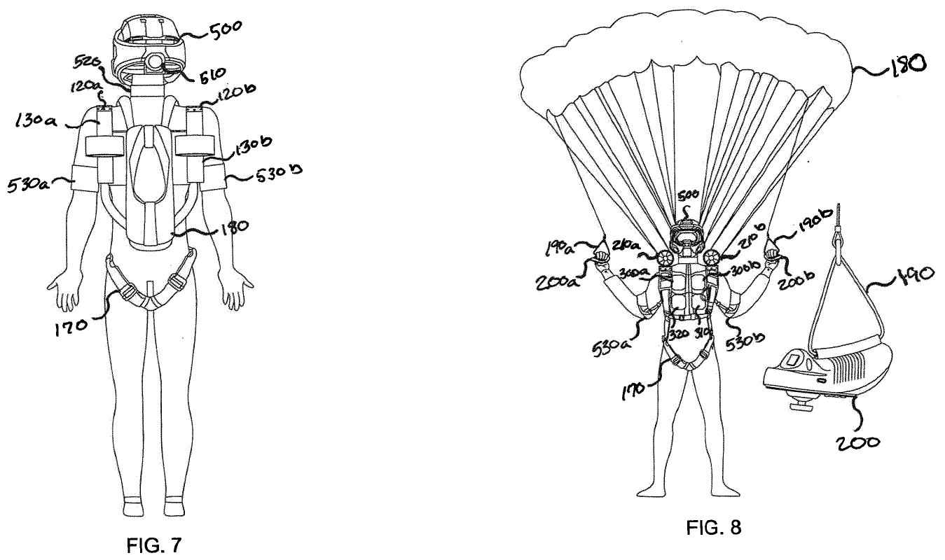

In FIGS. 6 to 7 is only the side and back view of the visible form of the aircraft, with flight systems in accordance with the Invention.

In FIG. 8 you will see the visible forms of the aircraft remote controllers.

The controls 200 a is preferred to consist of two input devices (one on each hand). The first input device provides a variable signal and can be used to control the amount of thrust provided by the propulsion units 210 a. The second input device is preferably the kill switch, which must be depressed by the user in order to deactivate the propulsion units 210 a. It's not necessary that both the left hand and right hand be deactivated by the left hand second input. Each remote control provides its own input and output of each propulsion unit 210.

The control 200 b is preferred to consist of two input devices (one on each hand). The first input devices provides a variable signal and can be used to control the amount of thrust provided by the propulsion units 210 b, the second input device is preferably the kill switch, in which must be depressed by the user in order to prevent deactivation of the propulsion units 210 b, It's not necessary that both the left hand and right hand be deactivated by the right hand second input. For each remote control 200 will provide an input or output that activates or deactivates the propulsion units 210.

The mounted electrically-powered fan method may include measuring a rate of speed, and of direction, and adjusting the output of the thrust system, based at least in part, on the measured rate of speed and direction. The rate of changing a direction, may change at a yaw rate. This method may include adjusting the direction of the thrust systems to achieve a left or right change of direction, usually by adjusting the propulsion units in a opposite horizontal or downward position, for the aircraft to change direction or for it to be stabilizing.

Whilst the remote controllers 200 may independently control the left-side and right-side propulsion units 210. it is preferred that they each provide the same thrust. Thus, in preference the control signals may include: a throttle signal generated by controls 200, that controls the mounted electric powered fan.

The thrust system preferably includes two mounted electrically-powered fans to the propulsion holders 130. The controller may be in communication with the thrust system, and the controller may be configured to adjust an output of the direction of the thrust system based at least in part on the calculated differences. The thrust system may be configured to provide downward or upward lift to the body holdster 100, during operation with the parachute, in which may be configured to provide yaw adjustment to the device during operation.

Most preferably, the remote control 200 is ergonomically-shaped to the user's hand as comfortably as possible. As a result, a left-hand remote controller, may have a left-handed grip while a right-hand remote controller, may have a right-handed grip One or both of the left-right handed grip will have a hand grip that can attach to the parachute handles 190.

FIG. 8 is the totality in visible form of the invention in operation with the protective gear, but the protective gear as merely optional; in practice, it's suitable for training individuals but can be used without such a frame.

However, protective gears 500, 520, 530a and 530b, are useful for less trained individuals to protect their relative body parts. The head 500, the neck 520, the left arm 530a and right arm 530b are made with a predetermined degree of freedom, which may be removed, to provide more flexibility. This would allow the user to use the “Flight Suit” in a way to better operate the aircraft.

The protective gear would comprise of composite materials like aluminum or titanium or standard padding, foam or with clothing materials covering the user specified body part. Usually these protective gear are usually between 3 to 36 inches in length, between 1 to 24 inches in width, and between 3 to 36 inches in height. It may have under each arm a armpit band 530. for allowing adduction or abduction of the arms, and for allowing circumduction of the upper arm. to support the arms in a lift up position, the user in this way is supported by the armpit band 530 to the user.

The Parachute 180 is usually stored in a backpack or storage but preferably in a backpack worn by the user, for when the backpack is opened, and the parachute spreads out, with its strings, and lifts the air, the parachute 180 has the potential to carry the user off the ground.

Each propulsion unit 210, produces thrust in a predetermined direction. As is known in the art, this may be achieved by accelerating air and/or combustion products in a horizontal direction of the propulsion unit 210.

Each propulsion unit 210 may be a turbine, a rocket, even a firearm but suitably, the turbine would be an electric jp turbine and/or jet cat turbine available from Germany, which is typically used in model aircraft or military drones.

But preferably, an electric ducted fan driven by an electric motor may be used as a propulsion unit 210. If it is required that the system may fly for an extended period, it is possible that the power supply could be connected to an extension to the extra battery, thereby increasing the flight time for the user.

The divergent propulsion units 210 of each propulsion holder 130 are preferably to the individuals like turbines (or ducted fans), so that it's more suited to the users with the divergent of thrusts pressures, which may be achieved by using a different turbine, that themselves can diverge in but by these preferable stabilizing angles and frameworks.

Furthermore, while a parachute 180 is needed for the aircraft to fly, the body propulsion Holdster 100 with protective gears for the flight suit, may have additions be provided as coverings. For example, there may be suitable coverings of the user or coverings of the flight system when the aircraft is worn, which may come with a difference in style and/or color in its coverings, merely only for a difference in outer appearance but sameness in workings. Alternatively (or additionally) the design may change in size in accordance with the invention, or the user may have an alternative difference in color, for its coverings, or additions to make the aircraft more suitable to the user interest, so that the aircraft may be more suited to the user.

1. The Invention relates to the gatherings of the propulsion units, that are worn near the users scapulas, to provide thrust that pushes the user forward, while the parachute carries the user off the ground creating an ultralight aircraft.

2. A wearable aircraft that uses a “Body Holdster” which contain one or more propulsion units, in which each will provide its own thrust or collectively that produce thrust while holding the users upper body.

3. The Invention provides the wearable aircraft with applied thrust directly downward or pushes the user forward around the user scapula region, which is a Body Holdster suited around the user's upper body.

4. A wearable flight suit that the user wearing the “Holdster” will be in a way that the “wearer” uses is in motion as such that it may not disrupt the wearer's natural sense of balance, movement of body, use of arms, hands and leg motion.

5. A Flight suit with propulsion systems that may be designed to find the most fitting measurement to the user's human body to make the Aircraft more Suited to the user.

6. A Propulsion holder mounted near the scapula region which comprises at least two propulsion units, the Propulsion holders mounted near the user scapulas, so that the air intake and exhaust from the Propulsion units is away from the user body and able to lift and soften the landing of the user, and in a way still allows air intake from the air flow.

7. The protective gear, additions, for the wearable suited aircraft, preferably includes a helmet, which comprises a head-up display, which may be equipped with the camera on the back of the helmet, with a protective gear for the neck, and a armpit band, that represents the lifting of the upper arms, to protect the arms from fatigue, when holding the parachute handles.

8. The support assembly is composed of at least two lifters, it's usually arranged to fit outside of the Body Holdster, but usually under the two propulsion holders, as a lifter to the propulsion holders. It may also be arranged to be attached to the user chest plate as an inner or outer garment to the Body Holdster.

9. A wearable ultralight suited aircraft with thrust systems that control the propulsion units, which are worn on the user upper body, while the user simultaneously controls the parachute.

10. A wearable aircraft that the user wearing the “Propulsion units” that are mounted to the users upper body, in a way that the “wearer” can use it in motion, as such, that it may not disrupt, the wearer natural sense of balance, movement of body, and use of arms and leg motion.

11. The Invention includes two Propulsion Units on a Body Holdster, located near the user scapulas, connected to the flight systems, that control the propulsion units, which are worn on the user upper body, while the user simultaneously controls the parachute, in addition the user will be attached to a harness that's connected to the parachutes, which is worn by the wearer, with protective gear assembled on the wearer.

12. A remote control for wearable suited aircraft that uses a Body Holdster that is preferred to consist of two input devices (one on each hand). The first input device provides a variable signal and can be used to control the amount of thrust provided by the propulsion units. The second input device is preferably the kill switch, in which must be depressed by the user in order to deactivate the propulsion units, Each remote control provides its own input and output on each hand to utilize the controls, and it's used to distribute the thrust of the Propulsion units on the Body Holdster to a pointed area.

13. The first motion system for the wearable suited aircraft which may be configured to provide an downward or upward lift to one or all of the propulsion units, This may be embodied in a single device to be worn near the user's scapula area, and may be formed with distributed devices, The first control system is arranged to provide control signals to each propulsion assembly, The first motion system may also be arranged to receive from the energy storage device.

14. The second motion system for the wearable suited aircraft, may be configured to provide a counter rotating or yaw adjustment to the propulsion units near the user scapula, to change of direction in which may be a yaw rate. The method includes change of direction to substantially stabilize or to achieve a yaw position.

15. The Propulsion units will be signally mounted on the Body Holdster near the wearer scapula, but in a slanted direction to the users scapula, with its net thrust, for space will be between the Propulsion unit and the body, near the user shoulders to scapula region, in which may further extend away from the user to a horizontal position.

16. The holding system for the wearable suited aircraft which also comprises an energy storage device for providing power to the body holdster propulsion units. This may comprise a fuel storage vessel for supplying fuel to turbines and/or batteries for powering fans and/or control circuitry. The energy storage is preferably provided in the form of a storage to be worn at the chest or mounted on the stomach of the user.

17. The propulsion holder's elevation angle is considered to be at zero or negative than zero, in the dorsal side of the body holdster, for it is at least 300°, preferably no more than 360°.

18. The Helmet and heads up display for a wearable suited aircraft with thrust systems that control the propulsion units, which are worn on the user upper body, while the user simultaneously controls the parachute, The Protective gear for the head of the user, comes with a flashlight, camera, led lights, and a heads up display, with padding on the inside, and a more preferably balance for the overall stability of flight during operation.

19. The protective gear for wearable ultralight aircraft with thrust systems in accordance with the Invention would comprise of composite materials like aluminum or titanium or standard padding, foam or with clothing materials covering the user specified body part.

20. A suitable coverings of the wearable aircraft and flight system which may comprise a difference in style and/or color in its coverings for a difference in outer appearance, but sameness in accordance with the Invention.
